(19) United States
(12) Patent Application Publication
(10) Pub. No.: US 2015/0263423 A1
(43) Pub. Date: Sep. 17, 2015

(54) Method and System for Multiband, Dual Polarization, and Dual Beam-Switched Antenna for Small Cell Base Station

(71) Applicant: Korea Advanced Institute of Science and Technology, Daejeon (KR)

(72) Inventors: Seong Ook Park, Daejeon (KR); Ngyuyen Viet Anh, Daejeon (KR); Byeong Yong Park, Daejeon (KR)

(73) Assignee: Korea Advanced Institute of Science and Technology, Daejeon (KR)

(21) Appl. No.: 14/222,567

(22) Filed: Mar. 21, 2014

(30) Foreign Application Priority Data
Mar. 12, 2014 (KR) 10-2014-0028686

(51) Int. Cl. H01Q 3/24; H01Q 21/30; H01Q 19/18; H01Q 21/24; H01Q 21/28

(52) U.S. Cl. CPC H01Q 3/24; H01Q 21/24; H01Q 21/28; H01Q 19/18; H01Q 21/30

(57) ABSTRACT

A method and a system for a multiband, dual polarization, and switch mode beamforming antenna for a small cell base station are disclosed. The disclosed system for a multiband, dual polarization, and switch mode beamforming antenna for a small cell base station may include: a dielectric substrate comprising a ground plane on which an antenna is disposed; a vertically polarized antenna reflector disposed on the dielectric substrate to be vertical thereto, and configured to induce forming of a vertically polarized beam; a vertically polarized antenna parasitic reflector that is a reconfigurable frequency selective reflector provided in a polyhedral structure for forming the vertically polarized beam; a horizontally polarized antenna reflector disposed on the dielectric substrate to be horizontal thereto and configured to induce forming of a horizontally polarized beam; and a plurality of switches configured to adjust a radiation mode of the vertically polarized beam and a radiation mode of the horizontally polarized beam.

### CROSS-REFERENCE TO RELATED APPLICATION

This application claims the priority benefit of Korean Patent Application No. 10-2014-0028686, filed on Mar. 12, 2014, in the Korean Intellectual Property Office, the disclosure of which is incorporated herein by reference.

### BACKGROUND

1. Field of the Invention

The present invention relates to pattern reconfigurable multiple antennas and a switch mode beamforming antenna, and more particularly, to a multiband, dual polarization, and switch mode beamforming antenna system in which a modified planar monopole antenna is used as a reflector. The present invention relates to a design of a switch mode antenna system of a small cell base station and is suitable for providing a relatively high channel capacity in a multi-antenna wireless communication.

2. Description of the Related Art

The tremendous advancement in wireless communication technologies has driven the demand for ultra-high speed multi-functional wireless communication in a single device. Accordingly, a multi-antenna multiple input multiple output (MIMO) communication system has been proposed. A multi-antenna system uses at least two antennas for each of a transmitter and a receiver to provide a relatively high channel capacity in a multipath fading environment. In general, a correlation between antenna elements in the multi-antenna system needs to be decreased to ensure the high channel capacity. Also, a channel capacity may be increased within a confined frequency spectrum using a beamforming antenna. In general, a base station antenna requires dual polarization, an omni-directional antenna pattern, and a high channel capacity when communication in all the directions is requisite.

It is known that a power angular spectrum is not uniform in an indoor or outdoor propagation environment. The power angular spectrum is directional and varies under different and various propagation conditions. Radiation patterns of a general multi-antenna system are static and thus, it may be difficult to receive signals from the dominant direction of arrival which results in a poor signal-to-noise ratio (SNR). Accordingly, it is important to design multiple antennas, for example, MIMO antennas capable of reconfiguring their radiation patterns while maintaining resonant frequency and reflection coefficient characteristics. Such antennas are known as pattern reconfigurable antennas (PRAs) and may change their radiation characteristics while maintaining an operating frequency.

There are various approaches to design PRAs for portable terminals or indoor base stations. Conventional phase shifting techniques use a plurality of antenna elements and increase the system complexity and thus, are unsuitable for antennas of the portable terminals or the indoor base stations. A general method to realize PRAs is to use parasitic radiation elements positioned to be adjacent to a reflector, which is widely used in a monopole or patch antenna structure. Also, the general method may be applicable to a multimode antenna structure having a symmetric structure. However, according to a change in a location of such an antenna on the ground plane, radiation characteristics of the antenna may be significantly changed.

Accordingly, in the emerging multi-antenna applications, radiation patterns of the respective antenna elements need to have an excellent reconfiguration capability. Also, optimal small PRAs suitable for small portable devices are required.

Switch mode beam reconfigurable antennas are very promising due to their relatively structure, excellent radiation characteristics, ease of fabrication, and low cost. An antenna structure or a parasitic radiation element is controllable by controlling a switch. Through this, a direction of a radiation pattern may be changed.

### SUMMARY

An aspect of the present invention provides a switch mode beamforming antenna that is provided in a simplified structure and may transmit data at a high rate even in an indoor environment that spatially gives limitations on data transmission and reception.

Another aspect of the present invention also provides a switch mode beamforming antenna that may obtain further diversified and precise beamforming modes to perform beamforming.

According to an aspect of embodiments, there is provided a multiband, dual polarization, and switch mode beamforming antenna system, including: a main printed circuit board (PCB); planar horizontally and vertically polarized antennas disposed on the main PCB; and a ground plane connected to one side of each of a feeder and a radiator, to ground a power fed from the feeder, the feeder being connected to one side of an antenna.

A plurality of parasitic radiation elements, each element including at least one switch on each plane of the antenna and a polyhedral structure, may be disposed on the planar vertically polarized antenna.

The planar vertically polarized antenna may operate in a multiband.

The planar vertically polarized antenna may be a planar monopole antenna.

A plurality of antenna elements, each including a plurality of switches, may be disposed on the planar horizontally polarized antenna.

The horizontally and vertically polarized antennas may perform beamforming by operating in at least one of a single antenna mode and a multi-antenna mode at the power supplied from the feeder.

Radiation patterns of the horizontally and vertically polarized antennas may be orthogonally disposed to minimize interference between adjacent antennas.

According to another aspect of embodiments, there is provided a transceiver for performing wireless communication, the transceiver including an antenna. The antenna may be disposed on a single substrate, and may include planar horizontal and vertical polarization antenna radiators, and a ground plane connected to one side of a feeder and the radiator, to ground a power fed from the feeder. The feeder may be connected to one side of the radiator. The antenna may perform beamforming using a plurality of switch modes.

According to still another aspect of embodiments, there is provided a system for a multiband, dual polarization, and switch mode beamforming antenna for a small cell base station, the system including: a dielectric substrate including a ground plane on which an antenna is disposed; a vertically polarized antenna reflector disposed on the dielectric substrate to be vertical thereto, and configured to induce forming of a vertically polarized beam; a vertically polarized antenna parasitic reflector that is a reconfigurable frequency selective reflector provided in a polyhedral structure for forming the vertically polarized beam; a horizontally polarized antenna reflector disposed on the dielectric substrate to be horizontal thereto and configured to induce forming of a horizontally polarized beam; and a plurality of switches configured to adjust a radiation mode of the vertically polarized beam and a radiation mode of the horizontally polarized beam.

The ground plane may be connected to one side of each of a feeder and the radiators, to ground a power fed from the feeder, and the feeder may be connected to one side of the antenna.

The vertically polarized antenna radiator and the horizontally polarized antenna radiator are configured to perform beamforming by operating in at least one of a single antenna mode and a multi-antenna mode at the power fed from the feeder.

The vertically polarized antenna radiator and the horizontally polarized antenna radiator may be orthogonally disposed to minimize interference between adjacent antennas.

A plurality of parasitic radiation elements, each element including at least one switch on each of planes of the vertically polarized antenna reflector and a polyhedral structure, may be disposed on the vertically polarized antenna radiator.

The vertically polarized antenna radiator may include a plurality of patches and is configured to operate in a multiband including a long term evolution (LTE) band and a wireless local area network (WLAN) band.

The vertically polarized antenna radiator may be a planar monopole antenna.

A plurality of antenna elements, each element including a plurality of switches including a plurality of patches, may be disposed on the horizontally polarized antenna radiator.

The switch may include a switch power circuit configured to control the switch, and may perform polarization beamforming in an omni-directional radiation mode or a predetermined directional radiation mode based on an ON/OFF state of the switch.

According to still another aspect of embodiments, there is provided a method of operating a multiband, dual polarization, and switch mode beamforming antenna for a small cell base station, the method including: controlling an antenna to induce forming of a vertically polarized beam and a horizontally polarized beam; controlling the antenna to select ON or OFF of a switch to determine a radiation mode of the vertically polarized beam and a radiation mode of a horizontally polarized beam; controlling the antenna to radiate the vertically polarized beam in a predetermined angular direction when the switch is ON; and controlling the antenna to radiate the vertically polarized beam omni-directionally when the switch is OFF.

The controlling the antenna to select ON or OFF of the switch may include controlling the switch using a switch power circuit.

The controlling the antenna to select ON or OFF of the switch may include switching off the switch by inactivating a plurality of vertically polarized antenna parasitic radiators that is configured as a plurality of reconfigurable frequency selective radiators.

The controlling the antenna to select ON or OFF of the switch may include switching on the switch by activating one of a plurality of vertically polarized antenna parasitic radiators that is configured as a plurality of reconfigurable frequency selective radiators.

The controlling the antenna to radiate the vertically polarized beam in the predetermined angular direction may include radiating the vertically polarized beam in a maximum radiation direction that is a direction opposite to a direction of a vertically polarized antenna parasitic radiator.

The controlling the antenna to radiate the vertically polarized beam in the predetermined angular direction may include radiating the vertically polarized beam in a direction that is predetermined based on a structure in which a vertically polarized antenna parasitic radiator is disposed.

According to embodiments, it is possible to maximize the system efficiency in an indoor wireless communication network by enabling beamforming in a variety of modes in a simple structure in which a wireless communication system employs a multiband, dual polarization, and switch mode beamforming antenna.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIGS. 1A and 1B, are a three-dimensional (3D) view and a side view of a multiband, dual polarization, and switch mode beamforming antenna according to an embodiment of the present invention, respectively.

FIG. 2 is a cross-sectional view of a vertically polarized antenna radiator according to an embodiment of the present invention.

FIG. 3 is a graph showing a frequency response of a vertically polarized antenna radiator based on a structure of the vertically polarized antenna radiator according to an embodiment of the present invention.

FIG. 4 is a view illustrating a horizontally polarized antenna radiator according to an embodiment of the present invention.

FIG. 5 is a graph showing a frequency response of a horizontally polarized antenna radiator based on a structure of the horizontally polarized antenna radiator according to an embodiment of the present invention.

FIG. 6, parts A and B, are circuit diagrams of a switch power circuit for controlling a switch according to an embodiment.

FIG. 7 is a graph showing measured scattering parameters of a fabricated antenna according to an embodiment of the present invention.

FIG. 8 illustrates examples of omni-directional radiation patterns of a vertically polarized antenna radiator.

FIG. 9 illustrates examples of radiation patterns of a multiband, dual polarization, and switch mode beamforming antenna according to a switch control.

FIG. 10 is a flowchart illustrating a method of operating a multiband, dual polarization, and switch mode beamforming antenna for a small cell base station according to an embodiment of the present invention.

### DETAILED DESCRIPTION

Reference will now be made in detail to exemplary embodiments of the present invention, examples of which are illustrated in the accompanying drawings, wherein like reference numerals refer to like elements throughout. Exemplary embodiments are described below to explain the present invention by referring to the figures.

An antenna system disclosed in the present invention relates to a beamforming antenna system for a small cell base station and offers significant advantages in terms of size, weight, cost, and performance. The present invention is suitable for a multiband, dual polarization, and switch mode beamforming antenna system for a small cell base station. A radiation pattern of each antenna in a predetermined mode of an operation frequency may be switched to cover 360 degrees on the horizontal plane, for example, the azimuth plane and from −70 degrees to +70 degrees on the vertical plane, for example, the elevation plane at intervals of 90 degrees while maintaining a reflection coefficient. Also, the disclosed antenna system is designed to operate in a long term evolution (LTE) (1.7 to 2.1 GHz) band and a wireless local area network (WLAN) (2.5 GHz and 5.5 GHz) band.

Electromagnetic signals go through multipath reflections and scattering in an indoor propagation environment and thus, need to have the capability of responding to various polarization components. The present invention provides a multiband, dual polarization, and switch mode beamforming antenna that may receive horizontally and vertically polarized signals and thus, is suitable for an indoor propagation environment.

Hereinafter, embodiments of the present invention are described with reference to the accompanying drawings.

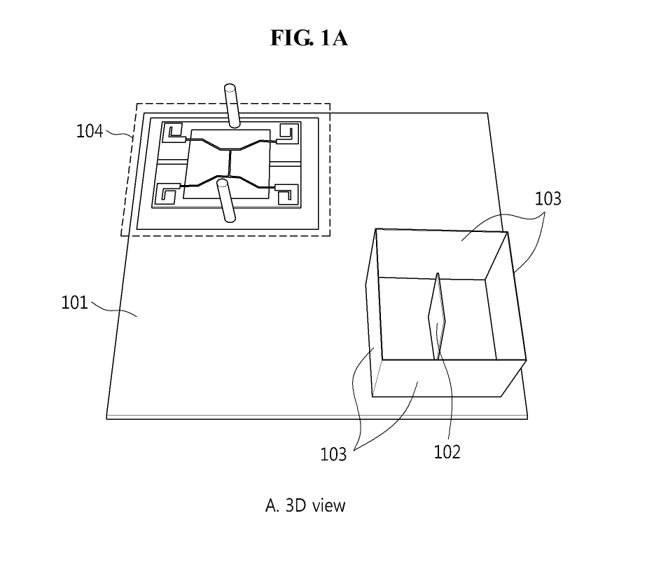

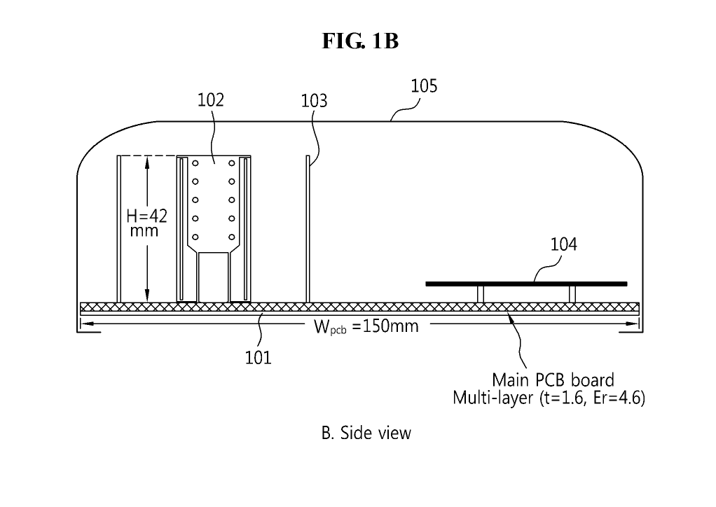

FIGS. 1A and 1B, are a three-dimensional (3D) view and a side view of a multiband, dual polarization, and switch mode beamforming antenna according to an embodiment of the present invention, respectively.

Referring to FIG. 1, a multiband, dual polarization, and switch mode beamforming antenna system (hereinafter, referred to as an antenna system) according to an embodiment of the present invention may include a dielectric substrate 101, a vertically polarized antenna radiator 102 provided in a planar type, a vertically polarized antenna parasitic radiator 103 provided in a planar type, a horizontally polarized antenna radiator 104 provided in a planar type, and an antenna system case 105.

As illustrated, the antenna system of the present invention may employ a modified planar monopole antenna.

The vertically polarized antenna radiator 102 is provided in a monopole antenna type, is printed on a FR4-substrate having a height of 0.8 mm and a size of 30×10×0.8 mm³, and is disposed on the dielectric substrate 101 to be vertical with respect thereto, in order to induce forming of a vertically polarized beam. For vertical polarization beamforming, the vertically polarized antenna radiator 102 is surrounded by the vertically polarized antenna parasitic radiators 103, which are also know as reconfigurable frequency selective reflectors (RFSRs) disposed in a polyhedral structure. The vertically polarized antenna parasitic radiator 103 of each plane is connected using a switch, and enables vertical polarization beamforming in an omni-directional radiation mode or a predetermined directional radiation mode, for example, switch mode, based on an ON/OFF state of the switch. Here, an additional power circuit for controlling the switch is included in the vertically polarized antenna parasitic radiator 103.

To induce the horizontal polarization, the horizontally polarized antenna radiator 104 is disposed to be in parallel with the dielectric substrate 101, and includes a plurality of antenna elements. Here, a separate switch is present on each antenna element and thus, the horizontally polarized antenna radiator 104 may form a horizontal polarization beam by controlling the switch of each antenna element. An additional power circuit for controlling the switch is included in the horizontally polarized antenna radiator 104.

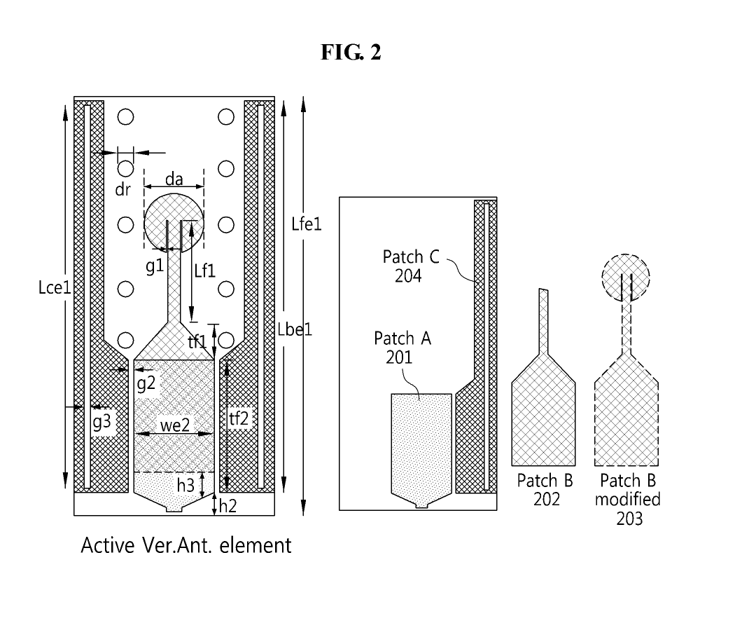

FIG. 2 is a cross-sectional view of the vertically polarized antenna radiator 102 according to an embodiment of the present invention. The vertically polarized antenna radiator 102 is a modified monopole antenna and includes three patches. Also, for vertically polarized switch mode beamforming, the vertically polarized antenna radiator 102 is surrounded by four RFSRs (hereinafter, the same reference numeral 103 is also used for the RFSR) that are vertically polarized antenna parasitic radiators 103. The vertically polarized antenna radiator 102 is separated from the center by about 25 mm through an optimization using a commercial EM simulation tool. The RFSR 103 is printed on a Teflon substrate with ∈r=2.2 and thickness of 0.508 mm. In general, to obtain a pulling pattern, the RFSR 103 has a length less than a length of the vertically polarized antenna radiator 102. Conversely, to obtain a pushing pattern, the RFSR 103 has a length greater than the length of the vertically polarized antenna radiator 102.

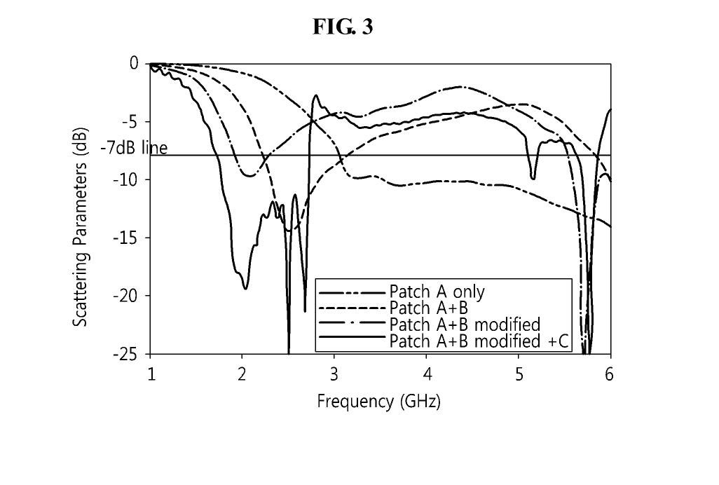

FIG. 3 is a graph showing a frequency response of a vertically polarized antenna radiator based on a structure of the vertically polarized antenna radiator according to an embodiment of the present invention.

Referring to FIGS. 2 and 3, the vertically polarized antenna radiator 102 includes three patches, and frequency response characteristics were verified based on the presence or absence of each patch. By locating a patch B 202 or a patch B modified 203 and a patch C 204 in addition to a patch A 201, an operation in a multiband including an LTE band (1.7 to 2.1 GHz) and a WLAN (2.5 GHz and 5.8 GHz) band was enabled.

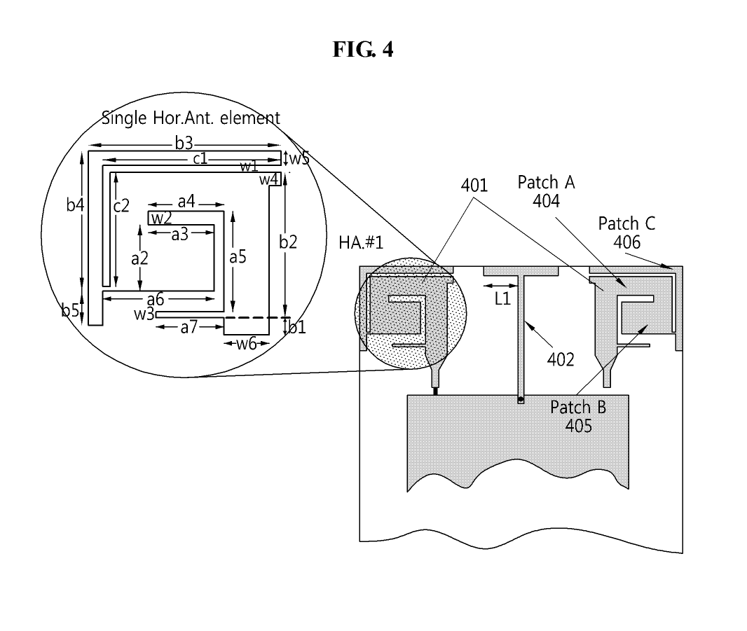

FIG. 4 is a view illustrating the horizontally polarized antenna radiator 104 according to an embodiment of the present invention. Referring to FIG. 4, the horizontally polarized antenna radiator 104 includes four antenna elements 401, a parasitic ground element 402 configured to improve an isolation between the antenna elements 401, and four radio frequency (RF) switches 403. Each antenna element 401 includes three patches 404, 405, and 406 for an operation in a multiband.

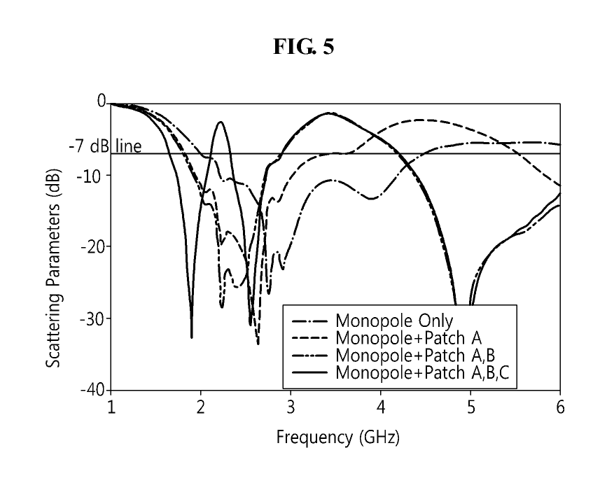

FIG. 5 is a graph showing a frequency response of the horizontally polarized antenna radiator 104 based on a structure of the horizontally polarized antenna radiator 104 according to an embodiment of the present invention.

Referring to FIGS. 4 and 5, the horizontally polarized antenna radiator 104 includes three patches, and frequency response characteristics were verified based on the presence or absence of each patch. By locating a patch B 405 and a patch 406 in addition to a patch A 404, an operation in a multiband including an LTE band and a WLAN band was enabled.

To determine a radiation mode of a vertically polarized beam and a radiation mode of a horizontally polarized beam, ON/OFF of a switch may be controlled to be selected. Here, the switch may be controlled using a switch power circuit. Accordingly, an additional power circuit for controlling a switch may be provided. The switch power circuit for controlling the switch may include a power circuit of the RFSR 103 for vertical polarization beamforming and the horizontally polarized antenna radiator 104 for horizontal polarization beamforming. The RFSR 103 may be configured as a rectangular reflector in various sizes for multiband beamforming. A size of a reflector is closely related to an operation frequency band and may be variously modified. The reflector is provided in a polyhedral structure and a single RF switch is required on each plane. The horizontally polarized antenna radiator 104 includes a plurality of antenna elements. A single RF switch is required for each antenna element. A diode or RF switch may be applied.

Based on an ON/OFF state of a switch, vertical polarization beamforming is enabled in an omni-directional radiation mode or a predetermined directional radiation mode, for example, a switch mode, of a vertically polarized beam and a horizontally polarized beam. The switch may be switched off by inactivating a plurality of vertically polarized antenna parasitic radiators 103 that is configured as a plurality of RFSRs. Conversely, the switch may be switched on by activating one of the plurality of vertically polarized antenna parasitic radiators 103 that is configured as the plurality of RFSRs.

When the switch is ON, the vertically polarized beam may be controlled to be radiated in a predetermined angular direction. Here, a maximum radiation direction may be formed to be opposite to a direction of the vertically polarized antenna parasitic radiator 103. Also, the vertically polarized beam may be radiated in the predetermined direction based on a structure in which the vertically polarized antenna parasitic reflector 103 is disposed with respect to the horizontally polarized beam. That is, the vertically polarized beam may be radiated in an omni-directional mode on a horizontal, that is, xy plane by inactivating the plurality of RFSRs 103 and switching off all the switches.

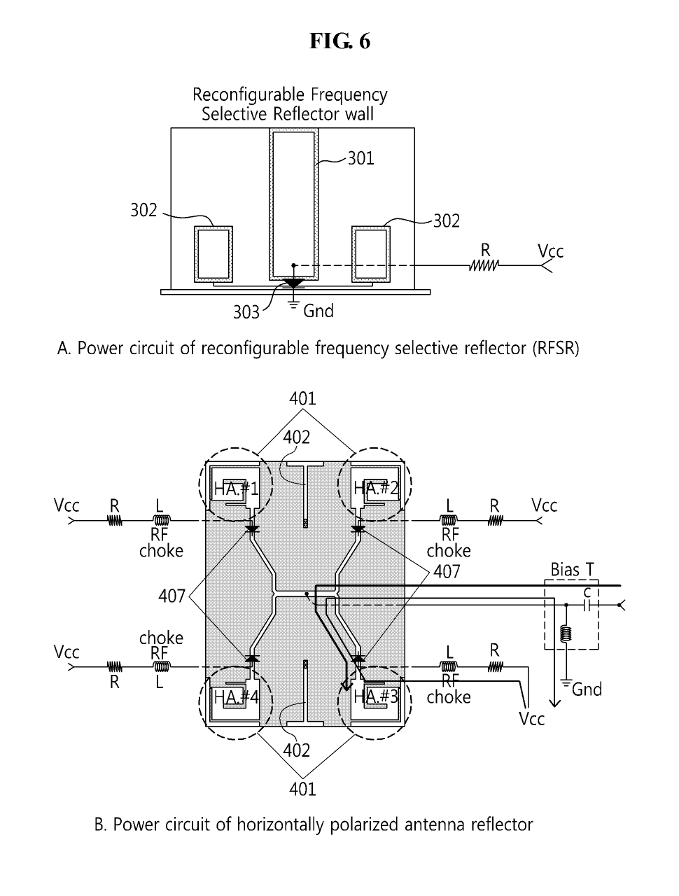

When the switch is OFF, the vertically polarized beam may be controlled to be radiated omni-directionally with respect to the horizontally polarized beam. That is, in the case of vertical polarization, a single RFSR may be activated among four RFSRs. Accordingly, by switching on a single switch, a corresponding RFSR may operate in a predetermined directional mode for forming a beam towards zero degrees, 90 degrees, 180 degrees, and 270 degrees on the horizontal (xy) plane. A maximum radiation direction may be formed to be opposite to a direction of the activated RFSR. An operation according to a switch control will be described with reference to FIGS. 6 through 9.

FIG. 6, parts A and B, are circuit diagrams of a switch power circuit for controlling a switch according to an embodiment, that is, a circuit diagram of the RFSR 103 for vertical polarization beamforming and the horizontally polarized antenna reflector 104 for horizontal polarization beamforming. The RFSR 103 may include rectangular reflectors 301 and 302 in various sizes for multiband beamforming. A size of a reflector is closely related to an operation frequency band and may be variously modified. The RFSR 103 is provided in a polyhedral structure and a single RF switch 303 is required on each plane.

The horizontally polarized antenna radiator 104 includes a plurality of antenna elements and a single RF switch 407 is required for each antenna element.

A diode or RF switch may be applied for the RF switches 307 and 407.

TABLE 1

| Parameter | VALUE | PARAMETER | VALUE | PARAMETER | VALUE |
|---|---|---|---|---|---|
| dr | 1.4 | tf1 | 3.75 | b4 | 9.785 |
| da | 3 | tf2 | 13.25 | b5 | 2.375 |
| Lce1 | 38 | Lf1 | 10.5 | c1 | 11.4 |
| Lbe1 | 39 | h2 | 2 | c2 | 8.36 |
| Lfe1 | 40 | h3 | 1.515 | a2 | 4.75 |
| we2 | 8 | wf | 40 | a3 | 4.75 |
| we3 | 5.5 | we2 | 6 | a4 | 5.225 |
| g1 | 0.2 | b1 | 1 | a5 | 7.125 |
| g2 | 0.5 | b2 | 11.5 | a6 | 8.075 |
| g3 | 0.75 | b3 | 12.825 | a7 | 4.75 |
| w1 | | w2 | 0.95 | w6 | 3.325 |

Table 1 shows optimized physical parameter values of a fabricated multiband, dual polarization, and switch mode beamforming antenna.

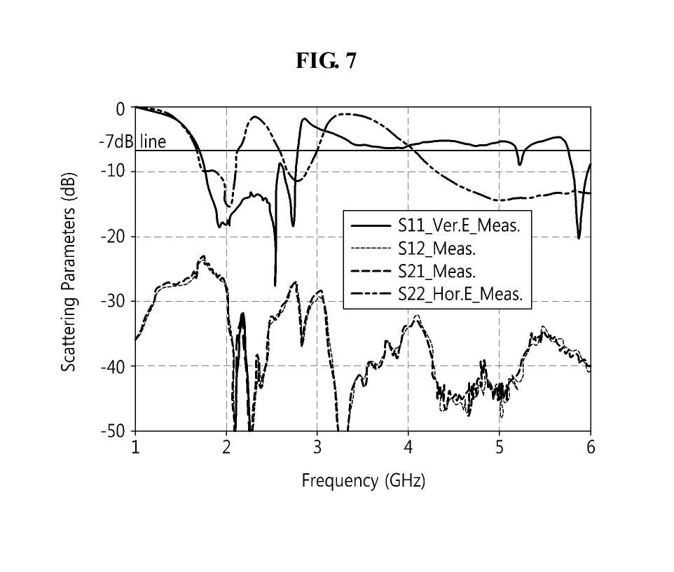

FIG. 7 is a graph showing measured scattering parameters of a fabricated antenna according to an embodiment of the present invention. The multiband, dual polarization, and switch mode beamforming antenna was fabricated based on optimized parameter values of Table 1. Fabricated horizontal and vertical antennas were measured using an Agilent-HP 8357A network analyzer and as a result, it can be known that both antennas operate in a multiband including an LTE band and a WLAN band. Further, as polarization diversity and spatial diversity, the isolation within an operation band was −25 dB or less and was very excellent.

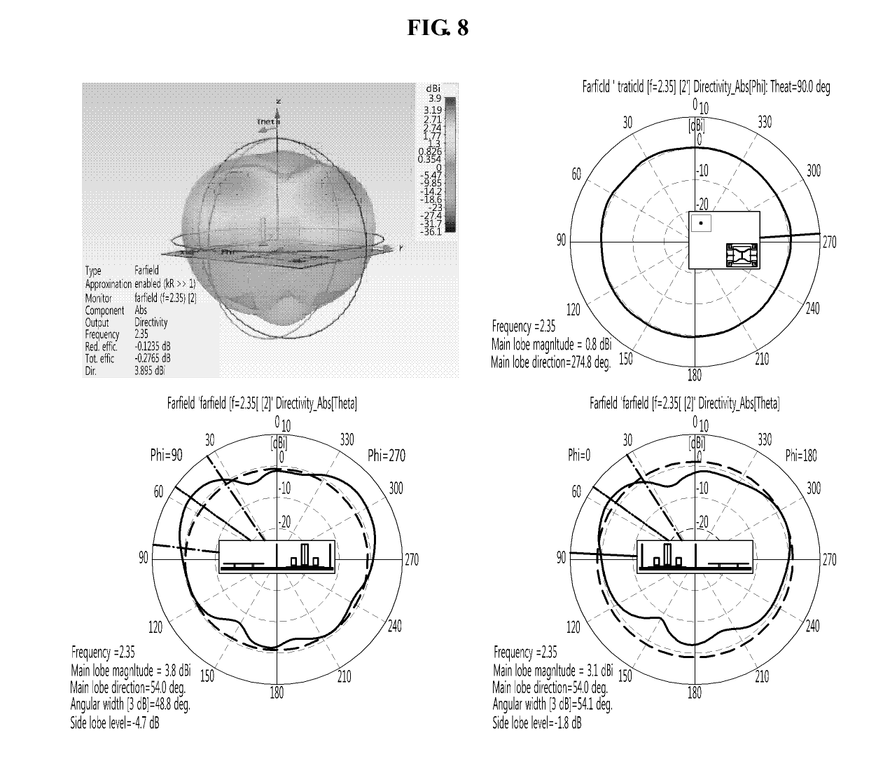

FIG. 8 illustrates examples of omni-directional radiation patterns of a vertically polarized antenna radiator. By inactivating the plurality of RFSRs 103, that is, by switching off all the switches, the vertically polarized antenna radiator 102 may radiate a vertically polarized beam in an omni-directional mode on the horizontal (xy) plane. The maximum directivity gain was 3.9 dBi with 30 degrees on the vertical plane, that is, the elevation plane.

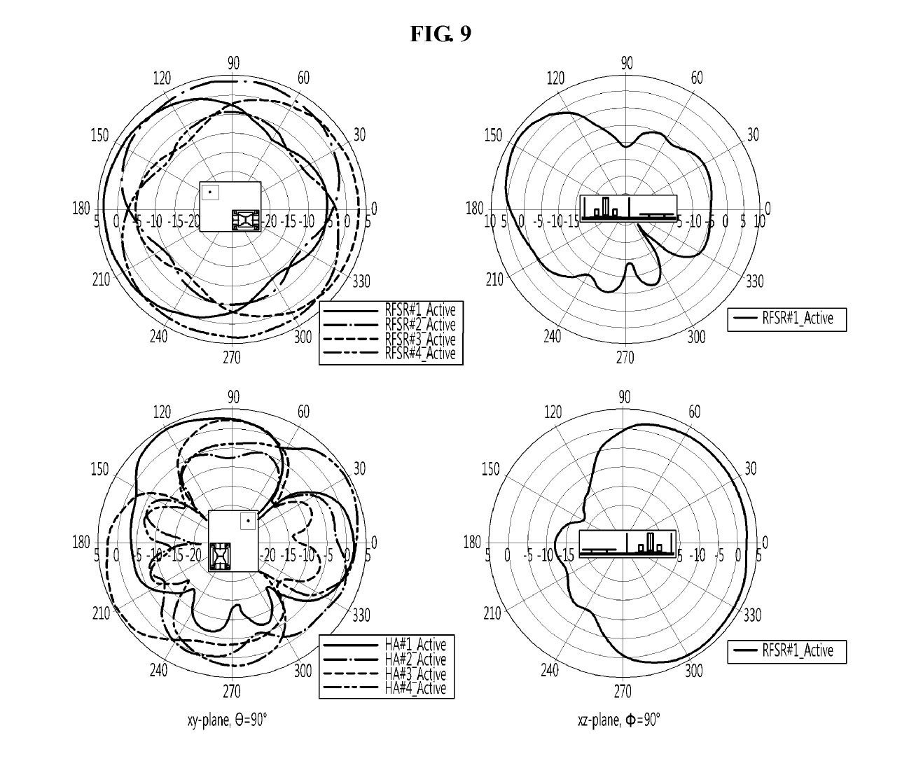

FIG. 9 illustrates examples of radiation patterns of a multiband, dual polarization, and dual beamforming antenna according to a switch control. In the case of vertical polarization, by activating one of the RFSRs 103, that is, by switching on a single switch, a corresponding RFSR may operate in a predetermined directional mode for forming a beam towards zero degrees, 90 degrees, 180 degrees, and 270 degrees on the horizontal (xy) plane. A maximum radiation direction may be formed to be opposite to a direction of the activated RFSR. The maximum directivity gain in the predetermined directional radiation mode was 7.4 dBi. Also, a beam towards a predetermined direction may be formed based on a structure in which the RFSRs 103 are disposed.

In contrast, the horizontally polarized antenna radiator 104 allows only a predetermined directional radiation mode. By controlling an RF switch connected to each antenna element 401, beams towards 30 degrees, 120 degrees, 210 degrees, and 330 degrees may be formed.

The vertically polarized antenna radiator 103 and the horizontally polarized antenna radiator 104 of the antenna system may independently operate.

Although the present invention is described by referring to a few embodiments and drawings, the present invention is not limited to the embodiments and thus, those skilled in the art may make various changes and modifications from the description.

Therefore, the scope of the present invention should not be determined to be limited to the embodiments and should be determined by the claims and the equivalents thereof.

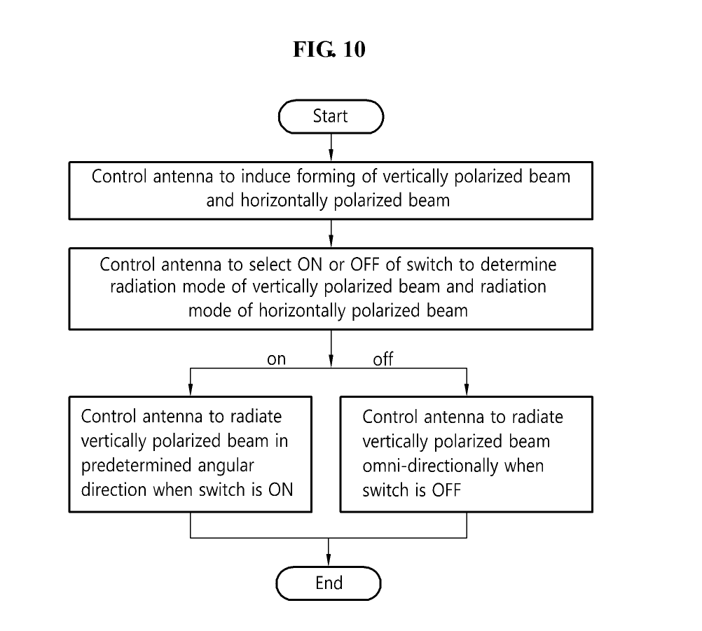

FIG. 10 is a flowchart illustrating a method of operating a multiband, dual polarization, and switch mode beamforming antenna for a small cell base station according to an embodiment of the present invention.

The method of the present embodiment may include operation 1010 of controlling the antenna to induce forming of a vertically polarized beam and a horizontally polarized beam; operation 1020 of controlling the antenna to select ON or OFF of a switch to determine a radiation mode of the vertically polarized beam and a radiation mode of a horizontally polarized beam; operation 1030 of controlling the antenna to radiate the vertically polarized beam in a predetermined angular direction when the switch is ON; and operation 1040 of controlling the antenna to radiate the vertically polarized beam omni-directionally when the switch is OFF.

In operation 1010, the antenna may be controlled to induce forming of the vertically polarized beam and the horizontally polarized beam. For example, a vertically polarized antenna radiator is provided in a monopole antenna type, may be printed on a FR4-substrate having a height of 0.8 mm and a size of 30×10×0.8 mm³, and may be disposed on the dielectric substrate to be vertical with respect thereto, in order to induce forming of the vertically polarized beam. Also, to induce forming of the vertically polarized beam, a horizontally polarized antenna radiator may be disposed to be in parallel with the dielectric substrate, and may include a plurality of antenna elements. Each antenna element includes a separate switch and thus, a horizontally polarized beam may be formed by controlling the switch of each antenna element.

In operation 1020, the antenna may be controlled to select ON/OFF of the switch to determine the radiation mode of the vertically polarized beam and the radiation mode of the horizontally polarized beam. Although not illustrated, operation 1020 may include controlling the switch using a switch power circuit. Accordingly, an additional power circuit for controlling the switch may be provided. The switch power circuit may include a power circuit of an RFSR for vertical polarization beamforming and the horizontally polarized antenna radiator for horizontal polarization beamforming. The RFSR may be configured as a rectangular reflector in various sizes for multiband beamforming. A size of a reflector is closely related to an operation frequency band and may be variously modified. The reflector is provided in a polyhedral structure and a single RF switch is required on each plane. The horizontally polarized antenna radiator includes a plurality of antenna elements. A single RF switch is required for each antenna element. A diode or RF switch may be applied.

Based on an ON/OFF state of a switch, vertical polarization beamforming is enabled in an omni-directional radiation mode or a predetermined directional radiation mode, for example, a switch mode of the vertically polarized beam and the horizontally polarized beam. In operation 1020, the switch may be switched off by inactivating a plurality of vertically polarized antenna parasitic radiators that is a plurality of RFSRs. In contrast, the switch may be switched on by activating one of the vertically polarized antenna parasitic radiators that is configured as the plurality of RFSRs.

In operation 1030, when the switch is ON, the antenna may be controlled to radiate the vertically polarized beam in a predetermined angular direction. In operation 1030, the maximum radiation direction may be formed to be opposite to a direction of the activated vertically polarized antenna parasitic radiator. Also, in operation 1030, the vertically polarized beam may be radiated in a predetermined direction based on a structure in which the vertically polarized antenna parasitic antenna is disposed with respect to the horizontally polarized beam. That is, by inactivating the plurality of RFSRs, that is, by switching off all the switches, the vertically polarized beam may be radiated in an omni-directional mode on the horizontal (xy) plane. For example, here, the maximum directivity gain may be 3.9 dBi with 30 degrees on the vertical plane, that is, the elevation plane.

In operation 1040, when the switch is OFF, the antenna may be controlled to radiate the vertically polarized beam omni-directionally. That is, in the case of vertical polarization, a single RFSR may be activated among four RFSRs. Accordingly, by switching on a single switch, a corresponding RFSR may operate in a predetermined directional mode for forming a beam towards zero degrees, 90 degrees, 180 degrees, and 270 degrees on the horizontal (xy) plane. A maximum radiation direction may be formed to be opposite to a direction of the activated RFSR. The maximum directivity gain in the predetermined directional radiation mode may be 7.4 dBi. Also, a beam towards a predetermined direction may be formed based on a structure in which the RFSRs are disposed.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system for a switch mode beamforming antenna, the system comprising:
a dielectric substrate comprising a ground plane on which an antenna is disposed;
a vertically polarized antenna reflector disposed on the dielectric substrate to be vertical thereto, and configured to induce forming of a vertically polarized beam;
a vertically polarized antenna parasitic reflector that is a reconfigurable frequency selective reflector provided in a polyhedral structure for forming the vertically polarized beam;
a horizontally polarized antenna reflector disposed on the dielectric substrate to be horizontal thereto and configured to induce forming of a horizontally polarized beam; and
a plurality of switches configured to adjust a radiation mode of the vertically polarized beam and a radiation mode of the horizontally polarized beam.

2. The system of claim 1, wherein the ground plane is connected to one side of each of a feeder and the radiators, to ground a power fed from the feeder, and the feeder is connected to one side of the antenna.

3. The system of claim 2, wherein the vertically polarized antenna radiator and the horizontally polarized antenna radiator are configured to perform beamforming by operating in at least one of a single antenna mode and a multi-antenna mode at the power fed from the feeder.

4. The system of claim 1, wherein the vertically polarized antenna radiator and the horizontally polarized antenna radiator are orthogonally disposed to minimize interference between adjacent antennas.

5. The system of claim 1, wherein a plurality of parasitic radiation elements, each element comprising at least one switch on each of planes of the vertically polarized antenna reflector and a polyhedral structure, is disposed on the vertically polarized antenna radiator.

6. The system of claim 1, wherein the vertically polarized antenna radiator comprises a plurality of patches and is configured to operate in a multiband comprising a long term evolution (LTE) band and a wireless local area network (WLAN) band.

7. The system of claim 1, wherein the vertically polarized antenna radiator is a planar monopole antenna.

8. The system of claim 1, wherein a plurality of antenna elements, each element comprising a plurality of switches comprising a plurality of patches, is disposed on the horizontally polarized antenna radiator.

9. The system of claim 1, wherein the switch comprises a switch power circuit configured to control the switch, and is configured to perform polarization beamforming in an omni-directional radiation mode or a predetermined directional radiation mode based on an ON/OFF state of the switch.

10. A method of operating a switch antenna, the method comprising:
controlling an antenna to induce forming of a vertically polarized beam and a horizontally polarized beam;
controlling the antenna to select ON or OFF of a switch to determine a radiation mode of the vertically polarized beam and a radiation mode of a horizontally polarized beam;
controlling the antenna to radiate the vertically polarized beam in a predetermined angular direction when the switch is ON; and
controlling the antenna to radiate the vertically polarized beam omni-directionally when the switch is OFF.

11. The method of claim 10, wherein the controlling the antenna to select ON or OFF of the switch comprises controlling the switch using a switch power circuit.

12. The method of claim 10, wherein the controlling the antenna to select ON or OFF of the switch comprises switching off the switch by inactivating a plurality of vertically polarized antenna parasitic radiators that is configured as a plurality of reconfigurable frequency selective radiators.

13. The method of claim 10, wherein the controlling the antenna to select ON or OFF of the switch comprises switching on the switch by activating one of a plurality of vertically polarized antenna parasitic radiators that is configured as a plurality of reconfigurable frequency selective radiators.

14. The method of claim 10, wherein the controlling the antenna to radiate the vertically polarized beam in the predetermined angular direction comprises radiating the vertically polarized beam in a maximum radiation direction that is a direction opposite to a direction of a vertically polarized antenna parasitic radiator.

15. The method of claim 10, wherein the controlling the antenna to radiate the vertically polarized beam in the predetermined angular direction comprises radiating the vertically polarized beam in a direction that is predetermined based on a structure in which a vertically polarized antenna parasitic radiator is disposed.
